(19) United States
(12) Patent Application Publication
(10) Pub. No.: US 2024/0185109 A1
(43) Pub. Date: Jun. 6, 2024

(54) QUANTUM SENSOR NETWORK AND MEASURING MULTIPLE FUNCTIONS WITH A QUANTUM SENSOR NETWORK

(71) Applicant: Government of the United States of America, as represented by the Secretary of Commerce, Gaithersburg, MD (US)

(72) Inventors: Alexey Vyacheslavovich Gorshkov, Potomac, DC (US); Jacob Bringewatt, Hyattsville, MD (US); Igor Boettcher, Edmonton (CA); Pradeep Niroula, College Park, MD (US); Przemyslaw Bienias, Silver Spring, MD (US)

(21) Appl. No.: 18/136,257

(22) Filed: Apr. 18, 2023

Related U.S. Application Data
(60) Provisional application No. 63/363,171, filed on Apr. 18, 2022.

(51) Int. Cl. G06N 10/20

(52) U.S. Cl. CPC G06N 10/20

(57) ABSTRACT

A process for measuring multiple functions with a quantum sensor network includes: providing a plurality of quantum sensors, each of which is configured for measuring a different analytic function of a set of unknown parameters; preparing the plurality of quantum sensors in a known state; exposing the plurality of quantum sensors to the set of unknown parameters; measuring the plurality of quantum sensors; and calculating the multiple analytic functions of the set of unknown parameters from the measurements of the plurality of quantum sensors

### CROSS REFERENCE TO RELATED APPLICATIONS

The application claims priority to U.S. Provisional Patent Application Ser. No. 63/363,171 (filed Apr. 18, 2022), the disclosure of which is incorporated herein by reference in its entirety.

### STATEMENT REGARDING FEDERALLY SPONSORED RESEARCH

This invention was made with United States Government support from the National Institute of Standards and Technology (NIST), an agency of the United States Department of Commerce and under Agreement No. W911NF1520067 awarded by the Army Research Lab, Agreement No. W911NF1410599 awarded by the Army Research Office, and Agreement No. W911NF16-1-0082 awarded by the Intelligence Advanced Research Projects Activity (IARPA). The Government has certain rights in the invention.

### BRIEF DESCRIPTION

Disclosed is a process for measuring multiple functions with a quantum sensor network that comprises: providing a plurality of quantum sensors, each of which is configured for measuring a different analytic function of a set of unknown parameters; preparing the plurality of quantum sensors in a known state; exposing the plurality of quantum sensors to the set of unknown parameters; measuring the plurality of quantum sensors; and calculating the multiple analytic functions of the set of unknown parameters from the measurements of the plurality of quantum sensors.

Disclosed is a quantum sensor network for measuring multiple functions with a quantum sensor network that comprises: a plurality of quantum sensors, each of which is configured to measure a different function of a set of unknown parameters; a network topology that connects the plurality of quantum sensors; and a controller that is configured to: prepare the plurality of quantum sensors in a known state; expose the plurality of quantum sensors to the set of unknown parameters; measure the plurality of quantum sensors; and use the measurements of the plurality of quantum sensors to calculate the multiple functions of the set of unknown parameters.

Disclosed is a process for making a quantum sensor network that measures multiple functions and that comprises: providing a plurality of quantum sensors, each of which is capable of measuring a different function of a set of unknown parameters; arranging the plurality of quantum sensors in a network topology; and connecting the plurality of quantum sensors to a controller.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a sequential protocol for measuring n≤d linear functions {f1(θ), . . . , fn(θ)} of d parameters θ=(θ1, . . . , θd), wherein the sequential protocol divides the problem into n parts, and each part is optimized to estimate a single function from the set {f1′, . . . , fn′} that can include linear combinations of the original set {f1, . . . , fn}.

FIG. 2 shows a local protocol for measuring n≤d linear functions {f1(θ), . . . , fn(θ)} of d parameters θ=(θ1, . . . , θd), wherein the local protocol does not use entanglement and measures parameters locally, providing large parallelization.

FIG. 3 shows a global protocol for measuring n d linear functions {f1(θ), . . . , fn(θ)} of d parameters θ=(θ1, . . . , θd), wherein the global protocol simultaneously estimates all functions.

FIG. 4 shows, according to some embodiments, a visualization for n=2 functions and d=3 sensors for optimally selecting a set of functions to measure whose coefficient vectors {α [symbol] ′} span the same subspace as the coefficient vectors { [symbol] } of the functions of interest. The vectors shown are the coefficient vectors, and the planes shown indicate the subspace spanned by the coefficient vectors. The axes are labeled by standard basis unit vectors {e1 , e2, e3}.

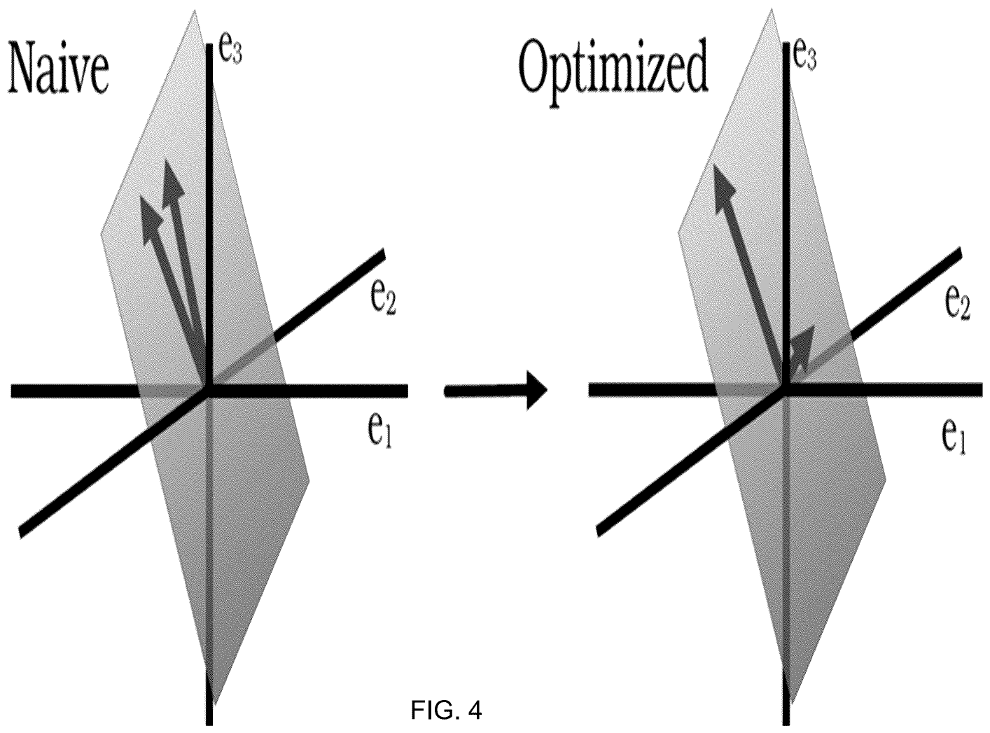

FIG. 5 shows, according to some embodiments: (a) a visualization for n=2 functions and d=3 sensors of geometrically symmetric functions. The coefficient vectors lie near the surface of a cone centered on some ω. (b) The opening angle of the cone is given by ϕ′, and the angular displacement from ϕ′ for a particular [symbol] ϵω, [symbol] as indicated in Eq. (31).

FIG. 6 shows, according to some embodiments, [symbol] ₛₛ versus [symbol] ₒₚₜ for 1000 random samples from the positive orthant of α₁, α₂ with n=2, w1=w2=1 for different numbers of sensors d. Dashed lines correspond to [symbol] _{local}. Colors correspond to the geometry parameter for the problem instance. Observe that the signed sensor symmetric approach is never worse than the local protocol, whereas the optimized sequential protocol can be. However, as d increases the optimized sequential protocol is almost always superior. Also recall, that for d>2, [symbol] ₛₛ is generically a lower bound.

FIG. 7 shows, according to some embodiments, [symbol] ₒₚₜ versus α₁·α₂ for n=2 functions and d=2 sensors. The nearly orthogonal case (α₁·α₂≈0) implies [symbol] ₒₚₜ≈4 (i.e., the worst case for the optimized sequential strategy). Compared to FIG. 6(a), [symbol] ₛₛ≈ [symbol] _{local}=2.

FIG. 8 shows, according to some embodiments, a summary of figures of merit. For strategies other than the signed sensor symmetric strategy, an explicit physical protocol achieves the given figure of merit. For the signed sensor symmetric strategy, beyond d=2, a state exists is not guaranteed to exist that achieves the figure of merit, and is a lower bound, given the signed sensor symmetric state restriction.

FIG. 9 shows, according to some embodiments, a s The figure of merit for the local strategy is [symbol] /t².

### DETAILED DESCRIPTION

A detailed description of one or more embodiments is presented herein by way of exemplification and not limitation.

It has been discovered that processes herein include quantum entanglement in a network of quantum sensors to precisely measure multiple smooth functions of fields at the quantum sensors. It is contemplated that in applications for geodesy, geophysics, biology, medicine, and the like, wherein sensors can be separated by a selected distance to measure temperature, a field (e.g., magnetic field, electric field, or a combination thereof), pressure, and the like, the processes apply when the fields at the sensors are different such as a sensor that measures electric field and another sensor that measures temperature. The processes can include an array of interferometers, and an array of field-quadrature displacement sensors, measuring functions of parameters some of which are measured by sensors, while others are measured by interferometers, while others are measured by field-quadrature displacement sensors, and the like.

For a Heisenberg scaler described in U.S. Pat. No. 11,562,049, the disclosure of which is incorporated herein by reference in its entirety, fields at individual sensors or phases of individual interferometers or field-quadrature displacements are first measured without entanglement between sensors or interferometers or field-quadrature displacement sensors to a precision sufficient for linearization of each of the desired analytic functions that one wants to measure. Thereafter, as herein described, the resulting linearized functions are measured by distributing selected entangled states across a network of sensors or interferometers or field-quadrature displacement sensors. For qubits, a first step of entanglement-free measurements can be done in a time proportional to T\hat{ }(⅗), where T is the total available time, and the fraction of time spent on this first step vanishes as T becomes longer and longer. Thus, time is spent on the optimal measurement of the linearized functions. For interferometers and field-quadrature displacement sensors, a first step of entanglement-free measurements can be done with a number of photons proportional to m\hat{ }(⅗), where m is the total number of photons available for the measurement, and the faction of photons used in this first step vanishes as m becomes larger and larger. The photons are spent on the optimal measurement of the linearized functions.

Quantum sensor networks have the potential to revolutionize the way we measure the world around us. By using the power of quantum mechanics, these networks can achieve unprecedented levels of precision and sensitivity. It has been discovered that a quantum sensor network 200 and a measuring multiple functions with a quantum sensor network provides simultaneous measurement of multiple functions of unknown parameters. This is a significant improvement over conventional technology that only measure one parameter at a time. The quantum sensor network 200 and a measuring multiple functions with a quantum sensor network can have a major impact on a wide range of applications, such as medical imaging, environmental monitoring, and national security.

In an embodiment, a quantum sensor network is arranged such that a quantum sensor at position x feels a field that depends, via a known function, on a known position x and a set of unknown parameters {p1, p2, . . . , pd}. Parameters {p1, p2, . . . , pd} can be, e.g., positions of charges producing an electric field. An entanglement-based protocol measures simultaneously multiple analytic functions of {p1, p2, . . . , pd}. The analytic functions can be, e.g., values of the field at points without a sensor or the integrals of the field over some regions. The entanglement-based protocol can measure properties of spatially varying fields such as magnetic fields, electric fields, gravitational fields, and temperature and can be used in applications in chemistry, medicine, biology, materials science, physics, geodesy, geophysics, and the like. Advantageously, the entanglement- based protocol performs better than conventional protocols by providing smaller uncertainty given a fixed time or providing a desired uncertainty in a shorter time.

Optimally measuring a single linearized function is described in U.S. patent application Ser. Nos. 16/677,922 and 15/650,216, the disclosure of each which is incorporated by reference herein in its entirety.

In an embodiment, for n linearized functions, referred to as target functions 201, (e.g., provided by fᵢ in Eq. (5)), a process for measuring multiple functions with a quantum sensor network involves reducing the measurement of the target function 201 to a sequential measurement of individual linearized functions as follows. Instead of measuring the target functions 201, the process includes sequentially measuring a set of object functions 202, which are linear functions that span the same subspace as the target functions 201, to a obtain objective measurement results 203. After performing this measurement, the process includes calculating the target functions 201 from the objective measurement results 203. Here, the change between the target functions 201 and the object functions 202 is included in n×n change matrix C 204, e.g., as provided in Eq. (8).

Change matrix C 204, e.g., shown in Eq. (11), indicates selection of entries, i.e., selection of the object functions 202 and determination of the fraction of the total time for measuring each of the object functions 202. Here, Eq. (11) is optimization over change matrix C 204 and over the time fractions. Optimization over time fractions can be done analytically, and the answer is indicated in Eq. (26). With this optimal choice of time fractions, the remaining optimization over change matrix C 204 is given in Eq. (25).

The formulas can be simplified by selective normalizations of columns of change matrix C 204, as indicated in Eq. (28), Eq. (29), or Eq. (30).

In an embodiment, the quantum sensors 205 are each coupled to correlated field amplitudes, as described in U.S. patent application Ser. No. 17/978,420, the disclosure of which is incorporated by reference herein in its entirety. Instead of considering independent field amplitudes coupled to the quantum sensors 205, the d parameters coupled to the d sensors are specified by a known analytic parameterization by some set of k≤d parameters. In an embodiment, the process for measuring multiple functions with a quantum sensor network includes reducing the measurement of each target function 201 (e.g., which is a smooth function of the parameters) to the measurement of a linear combination of the fields at the quantum sensors 205 according to the process described in U.S. patent application Ser. No. 17/978,420 prior to performing the above-presented steps in the process for measuring multiple linear combinations of the fields at the quantum sensors 205.

It is contemplated that measuring multiple functions with a quantum sensor network is operable in numerous physical settings including qubit sensors, photons, and the like. For any quantum sensor network that measures a single linear combination of field amplitudes, the sequential approach of measuring multiple functions with a quantum sensor network can be used. In an embodiment, a plurality of d Mach-Zehnder interferometers replaces qubit sensors, wherein the local fields are replaced by interferometer phases. Here, a resource is the number of photons N available to distribute among the interferometers instead of the total time t. In this context, one can measure a single function with variance

$$= \frac{{‖ w ‖}_{1}^{2}}{{N}^{2}}$$

instead of that indicated in Eq. (4), and all else remains substantially the same. In an embodiment, the measurement of linear combinations of field-quadrature displacements occurs by using an entanglement-enhanced continuous-variable protocol. In an embodiment, a combination of these settings are present, wherein some field amplitudes are coupled to qubits, some to Mach-Zehnder interferometers, and some to field-quadrature displacements.

The physical system of the quantum sensor network 200 and measuring multiple functions with a quantum sensor network can include a network of quantum sensors such as a network of qubit sensors, a network of interferometers, a network of field-quadrature displacement sensors, or a combination thereof. The quantum sensors can be arranged in an array format, including a one-dimensional array, a two-dimensional array, or a three-dimensional array.

Physical system includes a plurality of quantum sensors that can include a two-level quantum system such as provided by qubits, a three-level quantum system such as provided by qutrits, a four-level quantum system, . . . , an m-level quantum system and the like, wherein m is an integer. It is contemplated that energy differences are measured between two levels so certain embodiments are described in the context of qubits. Exemplary quantum sensors include a nuclear spin, an electronic spin, any two chosen levels of a neutral atom, an ion, a molecule, a solid-state defect, a superconducting qubit, and the like. In an embodiment, quantum sensors include a neutral atom, an ion, a molecule, a solid-state defect (such as color center in diamond), a superconducting circuit, and the like, or a combination thereof. The energy differences between the two levels of each qubit sensor can depend linearly on an observable of interest such as an electric field, a magnetic field, a gravitational field, temperature, strain, and the like. These observables of interest can be produced by an analyte that can include a planet, an organism (e.g., a human), an organ (e.g., a brain or a heart), a tissue (e.g., cardiac tissue), a laser, a molecule (e.g., including macromolecule such as a protein or a nucleic acid), an atom, and the like. In the case of interferometers, the quantum sensor is the interferometer including a path that goes through the medium of interest and picks up a phase and a reference path that doesn't pick up a phase. The medium of interest can include a tissue, a cell, or any other medium that transmits light. In the case of field-quadrature displacement sensors, quantum sensors can include a bosonic mode that undergoes a field-quadrature displacement and a homodyne detector used to measure this field quadrature. The bosonic mode can describe mechanical motion where the parameters coupled to mode can be proportional to a force. The bosonic mode can describe photons where the parameters coupled to the mode can be proportional to a magnetic field via Faraday-rotation after passing through the medium. The bosonic mode can describe low-energy excitations of a large number of two-level atoms where the parameters coupled to the mode can be proportional to an applied electric or magnetic field.

In an embodiment, a process for measuring multiple functions with a quantum sensor network includes: providing a plurality of quantum sensors, each of which is configured for measuring a different analytic function of a set of unknown parameters; preparing the plurality of quantum sensors in a known state; exposing the plurality of quantum sensors to the set of unknown parameters; measuring the plurality of quantum sensors; and calculating the multiple analytic functions of the set of unknown parameters from the measurements of the plurality of quantum sensors. In an embodiment, the plurality of quantum sensors is arranged in a network. In an embodiment, the plurality of quantum sensors is qubits, interferometers, or field-quadrature displacement sensors. In an embodiment, the multiple analytic functions are linear combinations of the set of unknown parameters. In an embodiment, the multiple analytic functions are nonlinear combinations of the set of unknown parameters. In an embodiment, the set of unknown parameters is a set of field amplitudes, a set of temperatures, a set of pressures, a set of strains, a set of forces, a set of magnetic fields, a set of electric fields, or a set of gravitational fields.

In an embodiment, a quantum sensor network for measuring multiple functions with a quantum sensor network includes: a plurality of quantum sensors, each of which is configured to measure a different function of a set of unknown parameters; a network topology that connects the plurality of quantum sensors; and a controller that is configured to: prepare the plurality of quantum sensors in a known state; expose the plurality of quantum sensors to the set of unknown parameters; measure the plurality of quantum sensors; and use the measurements of the plurality of quantum sensors to calculate the multiple functions of the set of unknown parameters. In an embodiment, the plurality of quantum sensors is arranged in a linear array. In an embodiment, the plurality of quantum sensors is arranged in a two-dimensional array. In an embodiment, the plurality of quantum sensors is arranged in a three-dimensional array. In an embodiment, the plurality of quantum sensors is qubits, interferometers, or field- quadrature displacement sensors. In an embodiment, the multiple functions are linear combinations of the set of unknown parameters. In an embodiment, the multiple functions are nonlinear combinations of the set of unknown parameters. In an embodiment, the set of unknown parameters is a set of field amplitudes, a set of temperatures, a set of pressures, a set of strains, a set of forces, a set of magnetic fields, a set of electric fields, or a set of gravitational fields.

In an embodiment, a process for making a quantum sensor network that measures multiple functions includes providing a plurality of quantum sensors, each of which is capable of measuring a different function of a set of unknown parameters; arranging the plurality of quantum sensors in a network topology; and connecting the plurality of quantum sensors to a controller. In an embodiment, the plurality of quantum sensors is arranged in a linear array. In an embodiment, the plurality of quantum sensors is arranged in a two-dimensional array. In an embodiment, the plurality of quantum sensors is arranged in a three- dimensional array. In an embodiment, the plurality of quantum sensors is qubits, interferometers, or field-quadrature displacement sensors. In an embodiment, the network topology is a star topology, a ring topology, or a mesh topology. In an embodiment, the controller is a computer.

It is contemplated that Error! Reference source not found. and Error! Reference source not found. can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
computer-readable storage medium or data carrier (e.g., a computer- readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product);
a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

Entanglement in quantum metrology can facilitate more accurate measurements compared to what is possible with unentangled probes, e.g., as demonstrated for measuring a single parameter or a single analytic function of many parameters using quantum sensor networks, which are highly general models of quantum metrology. In these models, one considers an array of d quantum sensors, each coupled to a local parameter. One then seeks to optimally measure these local parameters directly (or some functions thereof) by selecting an initial state ρ0 for the sensors, a unitary evolution U by which the local parameters are encoded in the state, and a choice of measurement specified by a positive operator-valued measure (POVM).

While measuring a single analytic function of multiple parameters in this setting is a bona fide multi-parameter problem, the fact that one seeks a single quantity makes the problem of finding the information-theoretic optimum for the variance of the desired quantity easier than a more general multi-parameter problem; in particular, one can use rigorous bounds originally derived for the single-parameter case. However, estimating multiple quantities involves solving the general problem of designing provably optimal protocols for multi-parameter quantum estimation. This is a challenging problem, and the general problem has not yet been solved.

In an embodiment, a process for measuring n≤d analytic functions with a quantum sensor network of d qubit sensors is a protocol that outperforms conventional protocols. Geometric aspects of this problem include the orientations of vectors of coefficients associated with the functions. The geometry can determine protocol performance.

One can reduce the problem of measuring n analytic functions of the parameters to that of measuring n linear functions. In particular, one can consider spending some asymptotically (in total time t) vanishing time t1 measuring the local parameters to which the sensors are coupled and then the rest of the time t2=t−t1 measuring the n linear combinations that result from a Taylor expansion of each analytic function about the true values of the local parameters estimated in the previous step. While provably optimal in the single-function case (n=1), this reduction from analytic functions to linear functions is not necessarily optimal in the multi-function case. While we conjecture that the optimality of this reduction from analytic to linear functions does generalize to the multi-function case, as we do not claim general optimality of the protocols in this work, the reduction may be freely made without having to prove the veracity of this conjecture.

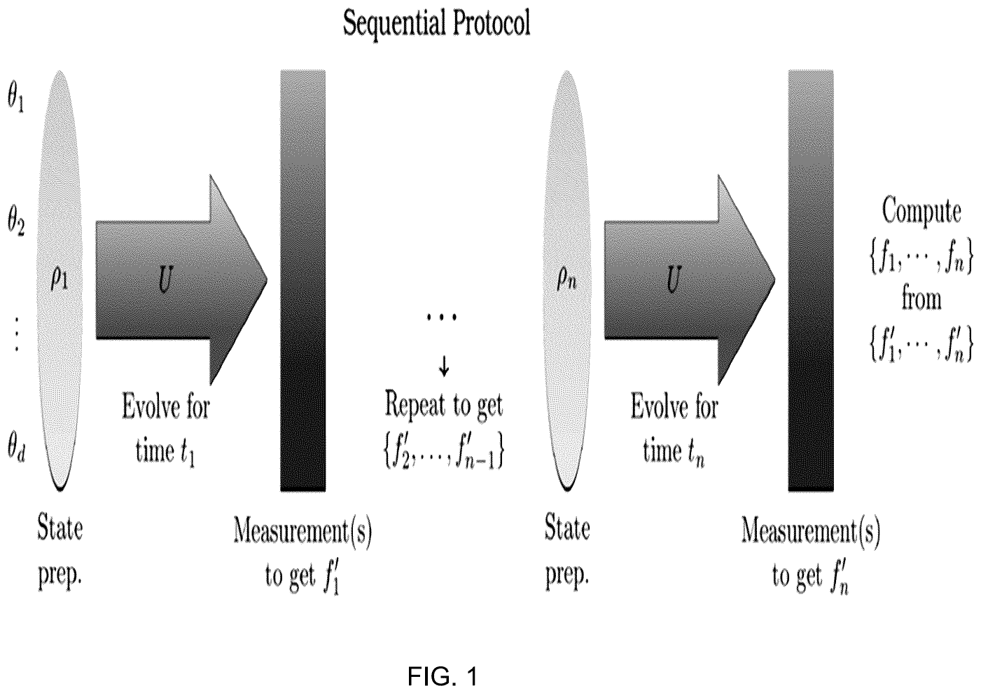

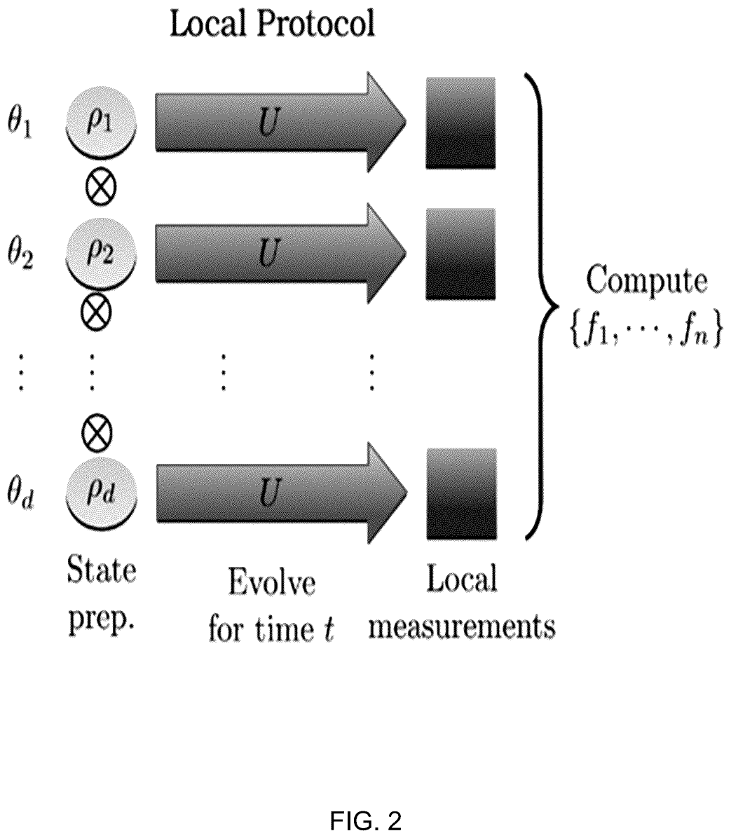

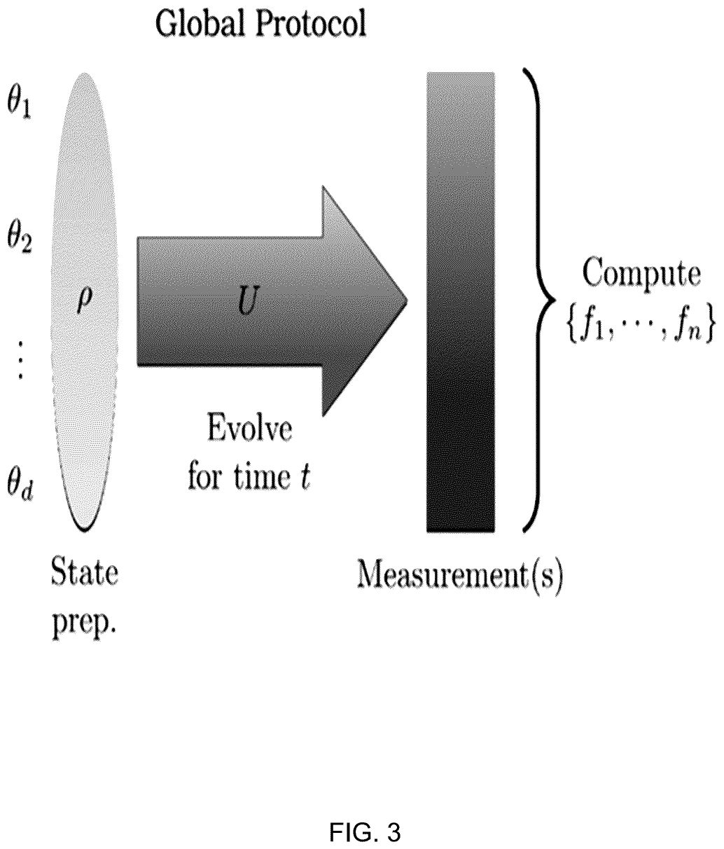

Having made this reduction to the problem of measuring multiple linear functions in a quantum sensor network, we qualitatively divide protocols for this problem into three classes: local (see FIG. 2), global (FIG. 3), and sequential (see FIG. 1). In a local estimation protocol, one optimizes only over unentangled input states and local measurements of the sensors. In a global protocol, one simultaneously estimates all the desired functions by optimizing over all (possibly entangled) input states and all (possibly non-local) measurements. Finally, in a sequential protocol, we divide the problem into n steps, wherein in each part we measure a single function (that can be a linear combination of the original set {f1, . . . , fn}), preparing a new (optimal) initial state and performing a new measurement in each step.

For the special case of measuring n=d orthogonal, linear functions (that is, linear functions such that the vectors of coefficients defining the linear functions are all mutually orthogonal), the functions can be measured optimally with a local protocol, but for general functions, proofs of optimal protocols are lacking. The only entanglement-enhanced approach found in the literature for measuring n>1 general linear functions in a quantum sensor network has a bound on performance for global protocols derived from the quantum Cramér-Rao bound subject to a set of sensor symmetric states; however, beyond the case of d=2, it is unknown whether the states and measurements (POVMs) required to saturate the derived bound exist for all problems because the bound is obtained by fixing v [defined in Eq. (15)] to be t²/4 and then optimizing [symbol] [defined in Eq. (14)] to obtain the best bound, such that there is not guaranteed a state corresponding to this pair of 4v=t² and the minimizing [symbol] , but the bound is a lower bound if one is allowed to use sensor symmetric states whether or not it can be saturated.

Here, we provide similar bounds using signed sensor symmetric states. However, the generalized version also does not guarantee that the optimal states and measurements exist in general. Also provided is an alternative, sequential protocol, subject to different restrictions, for which one can explicitly describe a protocol which achieves its theoretical performance. The geometric features of a given problem that impact the performance of this sequential protocol is compared to the signed sensor symmetric approach and the simple local protocol.

A quantum sensor network of d qubit sensors is prepared in some initial state ρ0. We then encode d local parameters θ=(θ1, θ2, . . . , θd)^{T} into the sensors via unitary evolution under the Hamiltonian

$$\hat{H} = {\hat{H}}_{c} ( t ) + {\sum }_{i = 1}^{d} \frac{1}{2} {θ}_{i} {\hat{σ}}_{1}^{z} , \qquad ( 1 )$$

with σi^{x,y,z} the Pauli operators acting on the i^{th} qubit, and θi the local parameter measured by the i^{th} sensor. The term Ĥ_{c}(t) is a time-dependent control Hamiltonian that may include coupling to ancilla qubits. When measuring a single function, this time-dependent control is not necessary to achieve an optimal protocol, and therefore, may freely be set to zero; however, one may use such control to design optimal protocols with simpler requirements on the choice of input state ρ0. Using this setup, our goal is to optimally measure n≤d functions f(θ)=(f1(θ), f2(θ), . . . , fn(θ))^{T}. In the following, we use i, j=1, . . . , d to label qubits and [symbol] , m=1, . . . , n to label functions. Boldface is used to denote vectors.

To compare the accuracy of the different approaches and to eventually optimize them, employ a standard figure of merit [symbol] as

$$ℳ = {\sum }_{ℓ = 1}^{n} {w}_{ℓ} Var {\tilde{f}}_{ℓ} , \qquad ( 2 )$$

where f are estimators of the functions and w=(w1, . . . , wn)^{T} is a vector of weights. Since an accurate protocol should yield small variances, we seek to minimize [symbol] In this context, given a total evolution time t, a protocol is defined by choice of initial state ρ0, control Hamiltonian Ĥ_{c}(t), measurements, and estimator f for f.

Figure of merit [symbol] is lower bounded via the Helstrom quantum Cramér-Rao bound, which yields

$$ℳ \geq \frac{1}{N} {\sum }_{ℓ = 1}^{n} {{w}_{ℓ} [ {ℱ}_{Q}^{- 1} ( f ) ]}_{ℓℓ} , \qquad ( 3 )$$

where N is the number of trials (which from now on we set to one for concision and consider just the single-shot Fisher information) and [symbol] Q(f) is the quantum Fisher information matrix with respect to the functions f. While this bound is not generally saturable, in the setting of Eq. (1) it is 2.

While saturable in the setting considered, the right hand side of Eq. (3) is not easily evaluated in general. If one seeks to measure a single linear function f(θ)=α·θ of the parameters θ, we may evaluate this bound and obtain that the minimum (asymptotically in time t and number of trials) attainable variance of an estimator f˜ of f(θ) over all quantum protocols is

$$Var \tilde{f} = {max}_{i} \frac{{\vert {α}_{i} \vert}^{2}}{{t}^{2}} . \qquad ( 4 )$$

This bound can be explicitly saturated by certain protocols. As previously described, if f(θ) is a more general analytic function, one may attain a similar bound using a two-step protocol. In the first (asymptotically negligible) step, one makes local estimates θ˜ of each of the parameters θ. In the second step, one uses the rest of the time to optimally measure the Taylor expansion of f(θ) about this estimate to linear order in θ.

For the case of measuring multiple functions f1, . . . , fn, we assume without loss of generality that the f [symbol] are linear functions in the parameters θ, because more general analytic functions could be similarly linearized in asymptotically negligible time. We parameterize the linear functions by real coefficient vectors [symbol] such that

$$\begin{matrix}{f}_{1} ( θ ) = {α}_{1} \cdot θ , \\ ⋮ \\ {f}_{n} ( θ ) = {α}_{n} \cdot θ .\end{matrix} \qquad ( 5 )$$

Defining the matrix elements A [symbol] i=(∂f [symbol] /∂θi)=( [symbol] )ᵢ, i.e., α [symbol] ^{T} is the [symbol] th row of A, we can phrase the problem as that of optimally measuring the n-component vector

Aθ=(α₁ . . . αₙ)^{T}θ. (6)

Without loss of generality, assume normalization of the coefficient vectors,

∥ [symbol] ∥²=1 for all [symbol] , (7)

because any non-unit length can be absorbed into the weights w in Eq. (2).

The problem of measuring n=d linear functions of independent parameters with quantum sensor networks has been considered in the literature in the case where the n functions are orthogonal (in which case local, global and sequential protocols are equivalent) and for general linear functions for global protocols when the input states ρ0 are restricted to be sensor symmetric. Here, we generalize the sensor symmetric approach and derive a performance bound when using so-called signed sensor symmetric input states (defined rigorously below). We refer to the variance obtained by the signed sensor symmetric protocol as [symbol] ₛₛ.

In this work, we also introduce an optimized sequential protocol for solving the n function estimation problem. We consider dividing our protocol into n sequential steps where, within each step, the protocol is provably information-theoretic optimal (i.e., saturates the quantum Cramér-Rao bound). In particular, for each step [symbol] ∈{1, . . . , n} taking time t [symbol] we measure a single function optimally using protocols. We cannot, however, prove that the full protocol is optimal in an information-theoretic sense. The naive version of this protocol is to measure the n given functions {f1, . . . , fn} one after another with some optimal choice of the time t [symbol] spent on each function. We denote the figure of merit of the naive sequential protocol by [symbol] ₙₐᵢᵥₑ.

However, the naive sequential protocol is not the only option for sequentially measuring multiple functions. Indeed, the coefficient vectors {α1, . . . , αn} span a linear subspace of [symbol] ^{d}, and we may instead sequentially measure any set of linear functions whose vectors of coefficients {α′1, . . . , α′n} span the same subspace and then (after the measurements) calculate the original functions {f1, . . . , fn}. To help understand this visually, this approach is depicted in the diagram in FIG. 2 for n=2 functions and d=3 sensors. We denote the figure of merit obtained via this method by [symbol] ₒₚₜ.

To be explicit, define the n×n matrix C encoding the change of linear functions via

A=CA′, (8)

where A′=(α′₁, . . . , α′ₙ)^{T} is the matrix whose rows are the coefficient vectors of the new linear functions we measure. The variance of measuring any individual [symbol] is given by the optimal linear protocol

$${ℳ}_{ℓ} = \frac{{μ}_{ℓ}^{′2}}{{t}_{ℓ}^{2}} , \qquad ( 9 )$$

where we introduce

$${μ}_{ℓ}^{′} = {‖ {α}_{ℓ}^{′} ‖}_{∞} = {max}_{j} \vert {α}_{ℓ , j}^{′} \vert = {max}_{j} \vert {\sum }_{m = 1}^{n} {( {C}^{- 1} )}_{ℓ m} {A}_{mj} \vert . \qquad ( 10 )$$

This corresponds to Eq. (4) for every [symbol] . We denote by μ′ the vector with entries μ′ [symbol] , and by μ the analogous vector for the original functions [obtained by setting C=I in Eq. (10)]. The figure of merit for estimating the original functions f with the optimized sequential protocol is then formally given by

$${ℳ}_{opt} = {min}_{C} {min}_{\{ {t}_{1} , … , {t}_{n} \}} [ {\sum }_{ℓ = 1}^{n} {\sum }_{m = 1}^{n} {w}_{m} {{C}_{m ℓ}^{2} ( \frac{{μ}_{ℓ}^{′}}{{t}_{ℓ}} )}^{2} ] , \qquad ( 11 )$$

that takes into account optimization over C and over the division of the total time into time steps t [symbol] , the factor [symbol] comes from the standard expression for a linear combination of variances and accounts for the linear change of functions. A more practical form of [symbol] ₒₚₜ will be derived below. If the naive sequential protocol were optimal, then the minimum of [symbol] ₒₚₜ would be attained at C=I. However, we will show in the following that choosing suitable C≠I often gives a significant improvement. This matches one's intuitive expectations—for example, if the coefficient vectors of all the functions are nearly aligned, we might expect that the optimal approach is to spend most of the time measuring a single function whose coefficient vector is in that general direction, and the rest of the time measuring functions with orthogonal coefficient vectors to distinguish the small differences in the functions of interest.

Parallelization can occur for certain choices of functions to measure, in particular, those sets of functions that depend on completely disjoint sets of sensors. When one chooses functions to measure such that A′ is the direct sum of matrices representing linear functions on disjoint sets of qubits, one could simultaneously measure functions that depend on disjoint sets of sensors, and thus spend more time measuring them, improving the accuracy. However, improved performance via parallelization is not guaranteed as Eq. (11) depends on both the time t [symbol] spent measuring a function and the infinity-norm of the coefficient vector, μ [symbol] =∥α [symbol] ∥∞—whereas parallelization improves the former, it may worsen that latter.

When n=d, the local strategy is a special case of such parallelization as it consists of measuring the local parameters all in parallel, and therefore a completely diagonal A′. As another simple example, suppose α1=(1, 1, 1)^{T}/\sqrt{3}, α2=(1, −1, 1)^{T}/\sqrt{3}, and α3=(0, 0, 1)^{T}. One way (amongst several) that this could be parallelized would be choosing to measure α1′=(1, 1, 0)^{T}\sqrt{2}, α2′=(1, −1, 0)^{T}/\sqrt{2}, and α3′=(0, 0, 1)^{T}; with this choice, one could, in parallel, estimate the sets of functions {α1′, α2′} and {α3′}.

Approaches to the problem include: (1) the local strategy with variance [symbol] _{local} (defined in Eq. (12)); (2) the (global) signed sensor symmetric strategy generalized with variance [symbol] ₛₛ; (3) the naive sequential strategy with variance [symbol] ₙₐᵢᵥₑ; and (4) the optimized sequential strategy with variance [symbol] ₒₚₜ. None of these four strategies is optimal in general. Depending on the geometry of the linear functions to be measured, each of these strategies could be the preferable one (excluding the naive strategy, which, of course, in the best case, has [symbol] ₙₐᵢᵥₑ= [symbol] ₒₚₜ). The term “geometry” here refers to the absolute and relative orientations of the coefficient vectors { [symbol] }. The question of what is the ultimate information-theoretic limit on [symbol] for multiple linear functions remains open. Here is described cases in which each of these known strategies is preferable with an emphasis on the geometric interpretation. The signed sensor symmetric and the optimized sequential strategy can out-perform the local unentangled strategy

### 3 The Strategies

The figure of merit [symbol] is determined for the four strategies. While the local and sequential strategies have explicit protocols to obtain the corresponding figure of merit, the figure of merit for the signed sensor symmetric is not proven to be always be attainable beyond d=2.

### 3.1 Local Strategy

The local strategy does not use entanglement. Since each local parameter θᵢ can be measured simultaneously, with a variance of 1/t²,

$${ℳ}_{local} = {\sum }_{ℓ = 1}^{n} {w}_{ℓ} \frac{{‖ {α}_{ℓ} ‖}^{2}}{{t}^{2}} = \frac{1}{{t}^{2}} {\sum }_{ℓ = 1}^{n} {w}_{ℓ} = \frac{𝒩}{{t}^{2}} , \qquad ( 12 )$$

where normalization of the α [symbol] is used and

$$𝒩 = {\sum }_{ℓ = 1}^{n} {w}_{ℓ} . \qquad ( 13 )$$

The local protocol performs independently of the geometry of the measured linear functions.

### 3.2 Signed Sensor Symmetric Strategy

The sensor symmetric approach uses signed sensor symmetric states. The restriction to (signed) sensor symmetric states gives a rigorous lower bound on the figure of merit [symbol] . However, unlike the local or sequential strategies, for d>2 one cannot guarantee that figure of merit [symbol] ₛₛ obtained via this approach is saturable. Define the generators of translations in parameter space as K=(K1, . . . , K_{d})^{T}, where Ki=i(∂U/∂θi)U† for evolution under the unitary U. Consider the Hamiltonian in Eq. (1) with Ĥc(t)=0, so that U=exp(−iĤt)) and Ki=σᵢ^{z}t/2. This restriction of Eq. (1) to evolution under a time-independent Hamiltonian is not necessary for the sequential protocols considered later. The single linear function results used as a subroutine of the sequential protocol, presents two protocols, one that matches this restriction and one that does not. When explicitly comparing the sequential protocol to the signed sensor symmetric problem, assume consideration of the former.

Given the generators of translations Kᵢ, the inter-sensor correlations are

$${𝒥}_{ij} = \frac{〈 {K}_{i} {K}_{j} 〉 - 〈 {K}_{i} 〉 〈 {K}_{j} 〉}{Δ {K}_{i} Δ {K}_{j}} \qquad ( 14 )$$

for i≠j, where we have used (ΔKᵢ)²= [symbol] Kᵢ² [symbol] − [symbol] Kᵢ [symbol] ². Given this definition, we define sensor symmetric states as those such that for all i≠j, [symbol] ij= [symbol] =c/v with

υ= [symbol] Kᵢ² [symbol] − [symbol] Kᵢ [symbol] ²,c= [symbol] KᵢKⱼ [symbol] − [symbol] Kᵢ [symbol] [symbol] Kⱼ [symbol] . (15)

For evolution under the time-independent version of Eq. (1),

$$v = \frac{{t}^{2}}{4} ( 1 - {〈 {σ}_{i}^{z} 〉}^{2} ) c = \frac{{t}^{2}}{4} ( 〈 {σ}_{i}^{z} {σ}_{j}^{z} 〉 - 〈 {σ}_{i}^{z} 〉 〈 {σ}_{j}^{z} 〉 \qquad ( 16 )$$

for all i≠j. The case of uncorrelated sensors, of course, is included for [symbol] =0.

Now we turn to a generalization of the sensor symmetric states referred to herein as signed sensor symmetric states. This generalization is natural as the (unsigned) sensor symmetric state construction picks out functions with coefficient vectors a aligned along the vector of all ones 1=(1, 1, . . . , 1)^{T} as being favorable, but the positive orthant is not special, and one can generalize from 1 being the favorable orientation to any ω∈{−1, 1}^{d} (of which 1 is just one example). Entanglement is helpful when one measures global, average-like quantities, which is what functions with coefficient vectors aligned along some ω are. This generalization is direct, as one can consider mapping any problem using a general ω by applying a Pauli-X operator on all qubit sensors corresponding to negative elements of ω and correspondingly flipping the signs of all corresponding coefficients specified by [symbol] . However, to fairly compare to the sequential protocol, consider all such w, as different choices can lead to an improved figure of merit. Relax the restriction on the numerator of [symbol] ij by defining

cᵢⱼ= [symbol] KᵢKⱼ [symbol] − [symbol] Kᵢ [symbol] [symbol] Kⱼ [symbol] (17)

and then restrict consideration to states such that

cᵢⱼ=c(ωω^{T})ᵢⱼ=cΩᵢⱼ, (18)

where ω∈{−1, 1}^{d} is a vector with all entries ±1 and c is a constant. The entries of Ωij are also ±1 and so cᵢⱼ=±c. We keep the definition [symbol] =c/v for our newly defined c, but note that now [symbol] ij=cᵢⱼ/v=± [symbol] .

When restricted to the (unsigned) sensor symmetric initial states, i.e. when ω=1 with 1=(1, . . . , 1)^{T} the vector of all ones, one is able to evaluate the quantum Cramér-Rao bound and determine the minimal achievable value for [symbol] , given the requirement of sensor symmetric input states. Define the ω-dependent geometry parameter [symbol] (ω), which encodes the geometric relationship between the coefficient vectors { [symbol] } of the n linear functions and the vector ω. Accordingly,

$$𝒢 ( ω ) = \frac{1}{𝒩} {\sum }_{ℓ = 1}^{n} {w}_{ℓ} ( d {cos}^{2} {ϕ}_{w , ℓ} - 1 ) . \qquad ( 19 )$$

Here ϕω [symbol] is the angle between the vectors [symbol] and ω. Thus cos ϕω, [symbol] = [symbol] ·ω/\sqrt{d}, and [symbol] (ω)∈[−1, d−1]. The relevance of this geometric quantity is clear as entanglement provides benefit when measuring functions aligned along some ω—that is, those functions for whom ϕω, [symbol] ≈0. The ω-dependent lower bound on the figure of merit is

$${ℳ}_{ss} ( ω ) = {min}_{𝒥} \frac{𝒩}{{t}^{2}} \frac{1 + [ d - 2 - 𝒢 ( ω ) ] 𝒥}{( 1 - 𝒥 ) [ 1 + ( d - 1 ) 𝒥 ]} , \qquad ( 20 )$$

where 4v=t² is used to obtain the lowest bound. Under this condition on v, and the assumption that [symbol] ∈(1/(1−d), 1), so that the quantum Fisher information is invertible, the minimum is attained for

$${𝒥}_{opt} ( ω ) = \frac{1}{𝒢 ( ω ) + 2 - d} [ 1 - \sqrt{\frac{( 𝒢 ( ω ) + 1 ) [ d - 1 - 𝒢 ( ω ) ]}{d - 1}} ] . \qquad ( 21 )$$

One obtains the theoretical best performance for a signed sensor symmetric strategy as

$${ℳ}_{ss} = {min}_{ω} {ℳ}_{ss} ( ω ) . \qquad ( 22 )$$

The obtainable accuracy is related to the geometry of the linear functions to measure. The best performance is when [symbol] is approximately d−1; that is, when ϕω, [symbol] ≈0, wherein sensor symmetric states have the largest inter-sensor correlations [symbol] ₒₚₜ (i.e., are most entangled).

### 3.3 Naive Sequential Strategy

In the naive sequential protocol, sequentially measure the n linear functions {f1, . . . , fn} using an optimal single linear function protocol. For this, determine the optimal times [symbol] spent to measure the [symbol] ^{th} function by minimizing Eq. (11) for C=I with respect to {t1, . . . , tn} under the constraint [symbol] =t. The solution to this Lagrange multiplier problem is

$${ℳ}_{naive} = \frac{1}{{t}^{2}} {( {\sum }_{ℓ = 1}^{n} {[ {w}_{ℓ} {μ}_{ℓ}^{2} ]}^{1 / 3} )}^{3} . \qquad ( 23 )$$

As an important example, consider equal weights, [symbol] ≡ [symbol] /n. Then

$$\frac{{n}^{2} 𝒩}{{dt}^{2}} \leq {ℳ}_{naive} \leq \frac{{n}^{2} 𝒩}{{t}^{2}} . \qquad ( 24 )$$

The upper bound is obtained for unfavourable functions { [symbol] } such that μ=1n (“worst case”), with 1n the n-component vector of ones, whereas the lower bound is obtained for favourable functions { [symbol] } with μ=1n/\sqrt{d} (“best case”). These are the two extreme possible cases. Compared to the local protocol figure of merit of [symbol] /t² for any choice of [symbol] , we see that in the worst case, the local protocol is always superior to the naive sequential protocol. Furthermore, even in the best case, we must have d>n² to obtain an advantage from the naive sequential protocol compared to the local protocol, implying a relatively large number of sensors. This shows that the naive sequential protocol, with C=I, is not very competitive. On the other hand, as we show now, by optimizing over C a significant gain in accuracy over the local protocol can be achieved.

### 3.4 Optimal Sequential Strategy

Finally, consider the optimal sequential protocol. The minimization over time in Eq. (11) proceeds as in the naive case but with a general C. Therefore, the optimal sequential protocol is

$${ℳ}_{opt} = {min}_{C} {\frac{1}{{t}^{2}} [ {\sum }_{ℓ = 1}^{n} {( {\sum }_{m = 1}^{n} {w}_{m} {C}_{m ℓ}^{2} )}^{\frac{1}{3}} {{μ}_{ℓ}^{′}}^{2 / 3} ]}^{3} , \qquad ( 25 )$$

with optimal time to measure the [symbol] th function given by

$${t}_{ℓ} = t \frac{{( {\sum }_{m = 1}^{n} {w}_{m} {C}_{m ℓ}^{2} )}^{1 / 3} {{μ}_{ℓ}^{′}}^{2 / 3}}{{\sum }_{p = 1}^{n} {( {\sum }_{m = 1}^{n} {w}_{m} {C}_{m p}^{2} )}^{1 / 3} {{μ}_{p}^{′}}^{2 / 3}} . \qquad ( 26 )$$

Inserting the definition of [symbol] from Eq. (10),

$${ℳ}_{opt} = {min}_{C} {\frac{1}{{t}^{2}} [ {\sum }_{ℓ = 1}^{n} {( {\sum }_{m = 1}^{n} {w}_{m} {C}_{m ℓ}^{2} )}^{\frac{1}{3}} {max}_{i} {\vert {\sum }_{m = 1}^{n} {( {C}^{- 1} )}_{ℓm} {A}_{m i} \vert}^{2 / 3} ]}^{3} . \qquad ( 27 )$$

Due to the appearance of both C and C⁻¹ in the expression with the same powers, the result is invariant under a change in the normalization of the columns of C. Therefore fix these column normalizations and introduce the constraint that

$${\sum }_{m = 1}^{n} {w}_{m} {C}_{m ℓ}^{2} = 1 , \qquad ( 28 )$$

for each [symbol] . Under this constraint, obtain the simpler expression

$${ℳ}_{opt} = {min}_{C} {\frac{1}{{t}^{2}} [ {\sum }_{ℓ = 1}^{n} {max}_{i} {\vert {\sum }_{m = 1}^{n} {( {C}^{- 1} )}_{ℓm} {A}_{m i} \vert}^{2 / 3} ]}^{3} , \qquad ( 29 )$$

with optimal time per function given by

$${t}_{ℓ} = t \frac{{{μ}_{ℓ}^{′}}^{2 / 3}}{{\sum }_{m = 1}^{n} {{μ}_{m}^{′}}^{2 / 3}} . \qquad ( 30 )$$

Geometrically, the constraint in Eq. (28) corresponds to restricting the columns of C to the surface of an (n−1)-dimensional ellipsoid (or (n−1)-sphere if wₘ= [symbol] /ln ∀m). The columns of C can then be efficiently parametrized by elliptical (or spherical) coordinates, and the optimization amounts to finding the best choice of corresponding angular variables. This choice of normalization can be made without loss of generality.

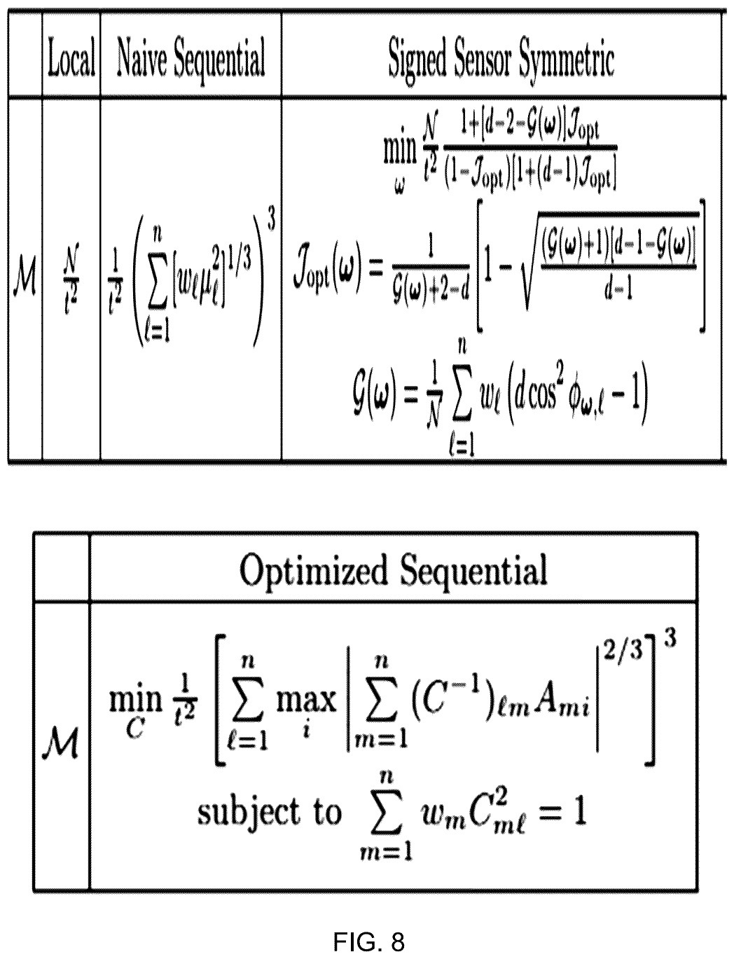

For the optimized sequential protocol, one can numerically perform the minimization over matrices C in Eq. (27) subject to the constraint in Eq. (28). Figures of merit calculated in this section are shown in FIG. 8.

### 4 Performance and Geometry

### 4.1 Geometrically Symmetric Limit

Begin by considering the geometrically symmetric limit of the signed sensor symmetric strategy. This limit is for comparing to the optimized sequential protocol. For this, consider a situation where the coefficient vectors [symbol] are all approximately the same angle ϕ′ from some ω, which is a vector with all elements ±1. This results simplifies the expression for the geometry parameter [symbol] . Define the parameter

[symbol]

= [symbol] −ϕ′, (31)

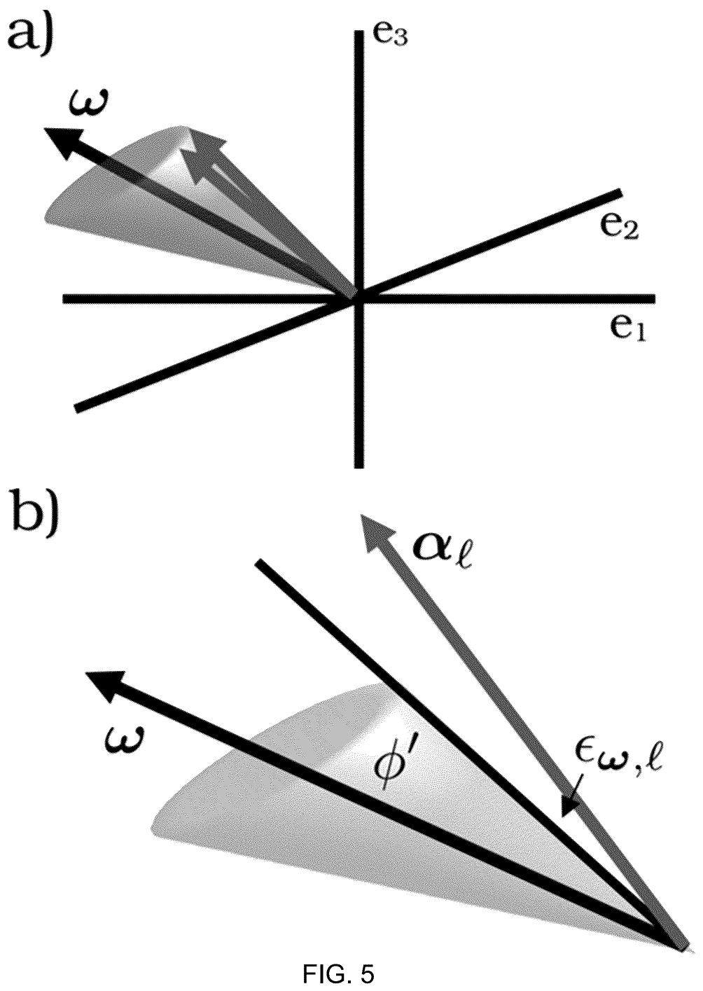

so that ϵω, [symbol] may be treated as a small parameter for a perturbative expansion, see FIG. 5.

The geometry parameter of the signed sensor symmetric strategy then reads

$$𝒢 ( ω ) = {𝒢}_{{ϕ}^{′}} ( ω ) + \frac{1}{𝒩} {\sum }_{ℓ = 1}^{n} {w}_{ℓ} d ( - 2 {ϵ}_{ω , ℓ} sin {ϕ}^{′} cos {ϕ}^{′} - {ϵ}_{ω , ℓ}^{2} cos ( 2 {ϕ}^{′} ) ) + 𝒪 ( {ϵ}_{ω , ℓ}^{3} ) . \qquad ( 32 )$$

Here, expand in powers of ϵω, [symbol] and define

$${𝒢}_{{ϕ}^{′}} ( ω ) + \frac{1}{𝒩} {\sum }_{ℓ = 1}^{n} {w}_{ℓ} ( d {cos}^{2} {ϕ}^{′} - 1 ) = d {cos}^{2} {ϕ}^{′} - 1 , \qquad ( 33 )$$

the geometry parameter for measuring a single function at an angle ϕ′ from ω. The condition on how small ϵω, [symbol] needs to be depends on ϕ′, but for any particular problem one can determine the condition. In general, as long as ϵω, [symbol] <<1/\sqrt{d}, the corrections will be negligible.

Consider Eq. (20) in the large-d limit and obtain

$${ℳ}_{ss} = \frac{𝒩}{{t}^{2}} ( 1 - \frac{𝒢 ( ω )}{d} ) + 𝒪 ( \frac{𝒩}{{dt}^{2}} \sqrt{\frac{( 1 + 𝒢 ( ω ) ) ( d - 𝒢 ( ω ) - 1 )}{d - 1}} ) , \qquad ( 34 )$$

for arbitrary values of ω. Substitute Eq. (32) and obtain, to leading order in the geometrically symmetric limit and for large d, that

$${ℳ}_{ss} ( ω ) \approx \frac{𝒩}{{t}^{2}} ( 1 - \frac{{𝒢}_{{ϕ}^{′}} ( ω )}{d} ) \approx \frac{𝒩}{{t}^{2}} ( {sin}^{2} {ϕ}^{′} + \frac{1}{d} ) . \qquad ( 35 )$$

For ϕ′=0, i.e., when all functions are nearly aligned with ω, this reduces to the optimal scaling [symbol] /(t²d).

These results are discussed in the following comparison of the signed sensor symmetric strategy to the optimized sequential strategy.

### 4.2 Nearly Overlapping Functions

Consider the case when all the vectors [symbol] are close in each component, i.e., consider measuring a set of n nearly identical functions. Intuitively, one would expect the optimal sequential strategy in this case to be spending almost all the time measuring the linear combination pointing towards the average of these functions, and then spending a small amount of time measuring in other directions in order to distinguish the small variations in the functions. One can analytically determine a scaling advantage (in d) for this protocol relative to the signed sensor symmetric strategy (and, of course, the unentangled strategy).

With regard to nearly overlapping, consider angles δ [symbol] associated with each vector of coefficients [symbol] as specified by

cos [symbol] = [symbol] ·α̅, (36)

where ā is a vector, with Euclidean norm equal to 1, chosen such that the average angle n⁻¹ [symbol] [symbol] is minimized. For δ [symbol] sufficiently small for all [symbol] [symbol] ≈ā for all [symbol] , and

$${max}_{i} {A}_{ℓ i} = {max}_{i} {\overline{a}}_{i} + 𝒪 ( {δ}_{ℓ} ) , \qquad ( 37 )$$

for [symbol] =( [symbol] )i. With δ= [symbol] , obtain from Eq. (29) that

$${ℳ}_{opt} = \frac{{max}_{i} {\overline{a}}_{i}^{2} + 𝒪 ( {δ}^{2} )}{{t}^{2}} {{min}_{C} [ {\sum }_{ℓ = 1}^{n} {\vert {\sum }_{m = 1}^{n} {( {C}^{- 1} )}_{ℓ m} \vert}^{2 / 3} ]}^{3} . \qquad ( 38 )$$

Leaving the somewhat tedious details to Section C, we find that this reduces to the expected result that

$${ℳ}_{opt} = \frac{𝒩}{{t}^{2}} {max}_{i} {\overline{α}}_{i}^{2} + 𝒪 ( \frac{𝒩 {δ}^{2}}{{t}^{2}} ) . \qquad ( 39 )$$

Note that, in general, δ<<1/\sqrt{d} ensures that this is a good leading-order approximation. This is a reduction in the variance by a factor of approximately (to order δ²) maxᵢāᵢ²∈[1/d, 1] compared to the local protocol in Eq. (12), or, when compared to the naive sequential protocol in Eq. (23), a reduction in the variance by a factor of order [symbol] (1/n²).

To compare to the signed sensor symmetric protocol, we note that this nearly overlapping case is merely a special case of the nearly geometrically symmetric case of the sensor symmetric protocol (provided δ is sufficiently small). In particular, δ is the relevant expansion parameter for our asymptotic approximations as ϵω, [symbol] ≤δ for all [symbol] . Therefore, to compare, we may simply use the previous results from Section 4.1 with corrections upper bounded by taking ϵω, [symbol] →δ.

Furthermore, to leading order, [symbol] ₛₛ= [symbol] ₛₛ⁽ⁿ⁼¹⁾, and similarly, Eq. (39) also has the leading-order expression [symbol] ₒₚₜ= [symbol] ₒₚₜ⁽ⁿ⁼¹⁾, where the right-hand sides correspond to the accuracy [symbol] times the single-function estimation figure of merit. Therefore, in order to compare the accuracy of both protocols for nearly overlapping functions, it is sufficient to compare their performance for single-function estimation.

Of course, for a single function, the sequential strategy is provably optimal so the signed sensor symmetric strategy performs the same as the sequential strategy for a single function. For the best case for both strategies—where all functions are oriented along some ω to order [symbol] (δ)—both approaches have a cost to leading order of [symbol] /(t²d), which is superior to the local protocol by 1/d. Also, for d=2, the time-independent protocol uses sensor symmetric states because the initial states are chosen from the set

$$\vert ψ 〉 = \frac{1}{\sqrt{2}} ( \vert 00 〉 + \vert 11 〉 ) \qquad ( 40 )$$

$$\vert ψ 〉 = \frac{1}{\sqrt{2}} ( \vert 01 〉 + \vert 10 〉 ) ,$$

and therefore, for all choices of functions with d=2 (where both approaches provide explicitly saturable bounds), the two protocols are identical and optimal.

For d>2, there may not exist physical states that obtain the figure of merit provided by the signed sensor symmetric strategy. However, even if one assumes the figure of merit [symbol] ₛₛ is attainable, the optimized sequential strategy can be a superior choice. There can be a scaling advantage in d for the sequential protocol in this nearly overlapping limit.

To demonstrate a scaling advantage of the sequential protocol over the signed sensor symmetric strategy, consider n nearly overlapping functions such that δ<<1/\sqrt{d} relative to the vector of coefficients given by

$$\overline{a} = \frac{1}{\sqrt{( {x}^{2} - {y}^{2} ) κ + {y}^{2} d}} {( {\underbrace{x , ⋯ , x}}_{κ} , {\underbrace{y , ⋯ , y}}_{d - κ} )}^{T} , \qquad ( 41 )$$

where the first κ elements are (up to normalization) x∈ [symbol] and the last d−κ elements are y∈ [symbol] . We assume x, y= [symbol] (1) and κ= [symbol] (d^{β}) for β ∈[0, 1). Without loss of generality, suppose x>y. In this case, the cost of the optimized sequential strategy is straightforwardly obtained from Eq. (39) to be

$${ℳ}_{opt} = \frac{𝒩}{{t}^{2}} ( \frac{{x}^{2}}{( {x}^{2} - {y}^{2} ) κ + {y}^{2} d} ) + 𝒪 ( \frac{𝒩 {δ}^{2}}{{t}^{2}} ) = \frac{𝒩}{{t}^{2}} \frac{{x}^{2}}{{y}^{2} d} ( 1 - \frac{( {x}^{2} - {y}^{2} ) κ}{{y}^{2} d} ) + 𝒪 [ \frac{𝒩}{{t}^{2}} ( {δ}^{2} + {d}^{2 ( β - 1 )} ) ] , \qquad ( 42 )$$

where the second line comes from expanding in powers of κ/d. For the signed sensor symmetric strategy for the same problem, we pick ω such that ωᵢ=sgn(āᵢ), which minimizes the angle between ā and ω. In the large d limit, then use Eq. (35) with

$${cos}^{2} {ϕ}^{′} = \frac{{( \overline{a} \cdot ω )}^{2}}{d} = \frac{{[ ( \vert x \vert - \vert y \vert ) κ + \vert y \vert d ]}^{2}}{d [ ( {x}^{2} - {y}^{2} ) κ + {y}^{2} d ]} . \qquad ( 43 )$$

Expand the numerator of Eq. (43) in powers of κ/d as

$${[ ( \vert x \vert - \vert y \vert ) κ + \vert y \vert d ]}^{2} = {\vert y \vert}^{2} {{d}^{2} [ 1 + \frac{( \vert x \vert - \vert y \vert ) κ}{\vert y \vert d} ]}^{2} = {\vert y \vert}^{2} {d}^{2} [ 1 + \frac{2 ( \vert x \vert - \vert y \vert ) κ}{\vert y \vert d} + 𝒪 ( \frac{{κ}^{2}}{{d}^{2}} ) ] , \qquad ( 45 )$$

and expand the denominator as

$$\frac{1}{d [ ( {x}^{2} - {y}^{2} ) κ + {y}^{2} d ]} = {\frac{1}{{y}^{2} {d}^{2}} [ 1 + \frac{( {x}^{2} - {y}^{2} ) κ}{{y}^{2} d} ]}^{- 1} = \frac{1}{{y}^{2} {d}^{2}} [ 1 - \frac{( {x}^{2} - {y}^{2} ) κ}{{y}^{2} d} + 𝒪 ( \frac{{κ}^{2}}{{d}^{2}} ) ] . \qquad ( 46 )$$

One obtains

$${sin}^{2} {ϕ}^{′} = 1 - {cos}^{2} {ϕ}^{′} = \frac{{( \vert x \vert - \vert y \vert )}^{2} κ}{{y}^{2} d} + 𝒪 ( \frac{{κ}^{2}}{{d}^{2}} ) , \qquad ( 47 )$$

which when put into Eq. (35) for the signed sensor symmetric strategy provides

$${ℳ}_{ss} = \frac{𝒩}{{t}^{2}} \frac{{( \vert x \vert - \vert y \vert )}^{2} κ}{{y}^{2} d} + 𝒪 [ \frac{𝒩}{{t}^{2}} ( {δ}^{2} + {d}^{2 ( β - 1 )} ) ] , \qquad ( 48 )$$

which shows a scaling advantage by a factor of [symbol] (κ⁻¹)= [symbol] (d⁻³) for the optimized sequential protocol in this problem.

For a single function for d=3 sensors and coefficient vector

$$α = \frac{1}{\sqrt{18}}$$

The was chosen such that for ω=1, [symbol] (ω)=0, and thus [symbol] ₒₚₜ(ω)=0, such that the optimal (unsigned) sensor symmetric state is unentangled. Equation (20) then implies

$${ℳ}_{ss} ( ω = 1 ) = \frac{1}{{t}^{2}} , \qquad ( 50 )$$

which is larger than the true optimal figure of merit, which is obtained by the sequential protocol:

$${ℳ}_{opt} = \frac{1}{{t}^{2}} {( \frac{\sqrt{2} + \sqrt{3} + 1}{\sqrt{18}} )}^{2} \approx \frac{0.9551}{{t}^{2}} . \qquad ( 51 )$$

If we extend to the signed sensor symmetric approach, one can consider ω=(1, 1, −1)^{T}. One obtains

$${ℳ}_{ss} ( ω ) = \frac{0.9554}{{t}^{2}} , \qquad ( 52 )$$

which is slightly worse than the true optimum and involves entanglement. Therefore, entanglement is helpful for measuring the function in Eq. (48), just not when we restrict to (unsigned) sensor symmetric states, and accuracy can be decreased when restricting to sensor symmetric states.

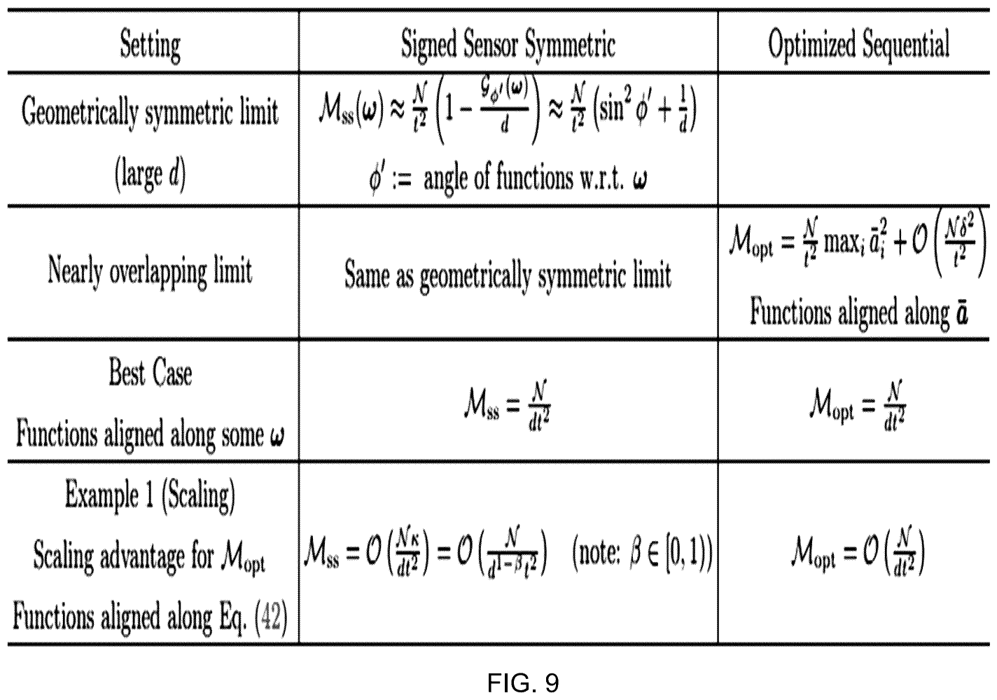

The analytic results comparing the signed sensor symmetric and optimized sequential strategies are shown in FIG. 9.

### 4.3 Numerical Results

The optimized sequential and signed sensor-symmetric strategies perform identically and optimally when measuring many functions whose coefficient vectors {α [symbol] } are aligned along a particular ω. The optimized sequential protocol typically outperforms the signed sensor symmetric strategy when measuring many functions with nearly overlapping coefficient vectors, and in fact, we can obtain a scaling advantage in d for certain problems. However, while informative, the nearly overlapping limit is such that the optimized sequential strategy performs its best.

Numerically, the optimization over C in Eq. (29), subject to Eq. (28), to obtain the cost of the optimized sequential protocol can be fairly costly in terms of computation time, as the optimization is non-convex and in a high dimensional parameter space. This is not necessarily an issue for particular applications, where only a limited number of such optimizations must be performed. As an example, consider n=2 functions, d≥n sensors, and equal weights in the figure of merit (w1=w2=1). The normalization condition (28) implies that the columns of the 2×2 matrix C have unit length. We can parametrize this by two angles via

$$C = ( \begin{matrix}cos φ & cos {φ}^{′} \\ sin φ & sin {φ}^{′}\end{matrix} ) . \qquad ( 53 )$$

Given the coefficient vectors α_{1,2} of the two functions to be estimated, the numerical optimization over φ, φ′ is accomplished straightforwardly. For n=3 functions, six angles φ1, . . . , φ6 are needed, making the optimization more challenging for larger n.

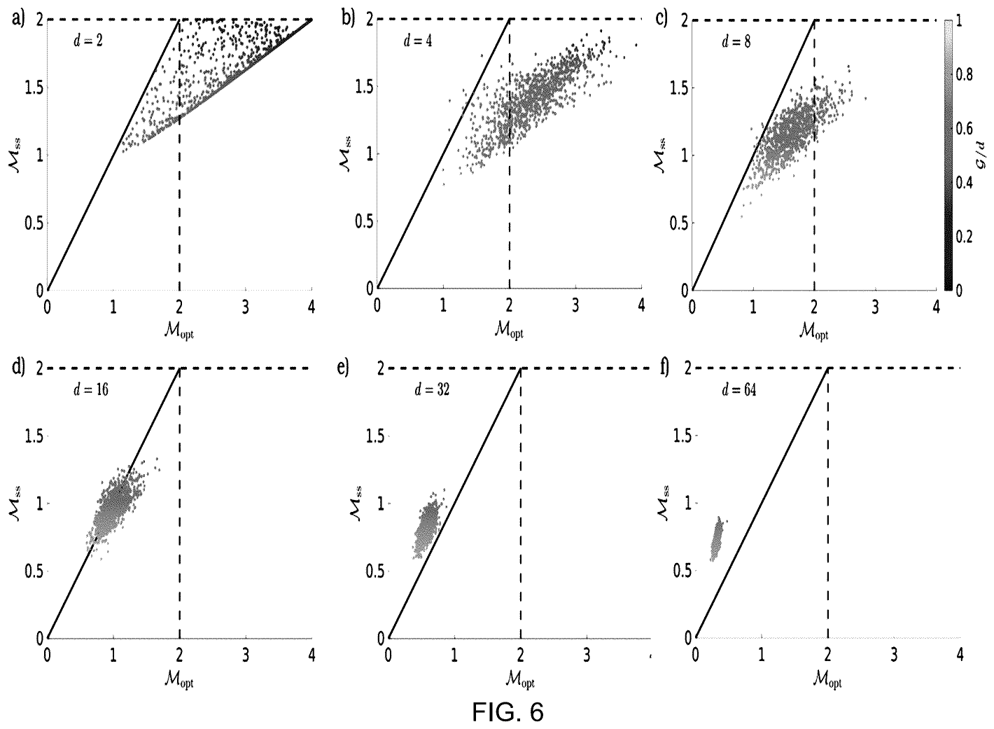

The two functions, represented by the two normalized coefficient vectors α_{1,2}, depend on 2(d−1) real parameters. In this context, randomly sample coefficients for the two functions from a uniform distribution and calculate the cost of the signed sensor symmetric strategy and the optimized sequential strategy. For d=2^{k} for k∈[1, 6], we consider 1000 such problems where for simplicity we assume that α_{1,2} are sampled from the positive orthant so that the optimal ω is necessarily 1 and plot the results in FIG. 6.

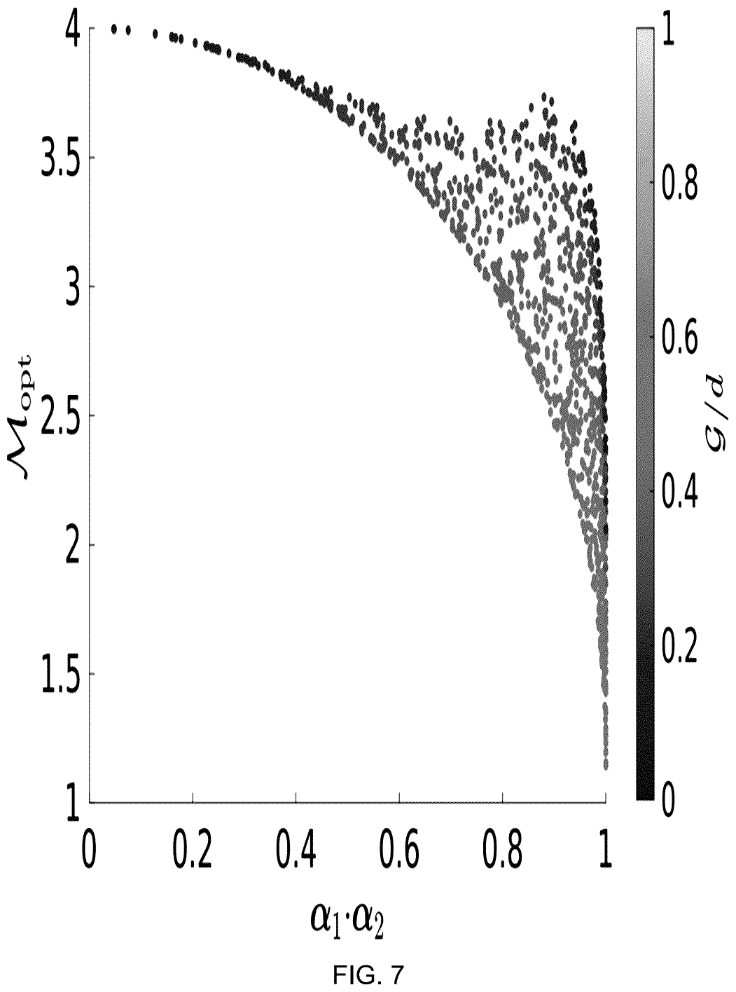

We observe that the signed sensor symmetric strategy is never worse than the local protocol, whereas the optimized sequential protocol can be at small d. In the particular case of n=d=2, the sequential strategy is never better than the signed sensor symmetric strategy. When the two functions are orthogonal, a local protocol obtains the optimal variance (that is, [symbol] = [symbol] /t² is optimal). In this case, the sensor symmetric strategy matches this known optimal result. In particular, the sensor symmetric strategy predicts an optimal geometry parameter [symbol] (ω)=0, corresponding to no inter-sensor correlations and, therefore, a local protocol. Observe this behavior in panel (a) of FIG. 6 where the [symbol] =0 points correspond to [symbol] ₛₛ= [symbol] _{local}=2. Note that cases of [symbol] ≈0 that correspond to nearly orthogonal coefficient vectors are only those points where [symbol] ₒₚₜ≈4, as can be concluded from FIG. 7 where we plot [symbol] ₒₚₜ versus α₁·α₂. As d increases, however, the optimized sequential protocol is almost always superior to both the local and signed sensor symmetric strategies for these randomized problem instances.

The sequential protocol can be extended to sensors that are each coupled to correlated field amplitudes, wherein instead of considering independent field amplitudes θi coupled to the sensors, one could consider the case where θ is specified by a known analytic parameterization by some set of k≤d parameters.

The sequential protocol can be extended to other physical settings beyond qubit sensors—namely, for any quantum sensor network where one may measure a single linear combination of field amplitudes, one can apply our sequential approach. For example, a collection of d Mach-Zehnder interferometers could replace the qubit sensors, where the role of the local fields is played by interferometer phases. Here, the limiting resource is the number of photons N available to distribute among interferometers as opposed to the total time t. In this context, one can measure a single function with variance

$$ℳ = \frac{{‖ w ‖}_{1}^{2}}{{N}^{2}}$$

—this replaces Eq. (4), and otherwise everything remains the same.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer- executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

What is claimed is:

1. A process for measuring multiple functions with a quantum sensor network, the process comprising:
providing a plurality of quantum sensors, each of which is configured for measuring a different analytic function of a set of unknown parameters;
preparing the plurality of quantum sensors in a known state;
exposing the plurality of quantum sensors to the set of unknown parameters;
measuring the plurality of quantum sensors; and
calculating the multiple analytic functions of the set of unknown parameters from the measurements of the plurality of quantum sensors.

2. The process of claim 1, wherein the plurality of quantum sensors is arranged in a network.

3. The process of claim 1, wherein the plurality of quantum sensors is qubits, interferometers, or field-quadrature displacement sensors.

4. The process of claim 1, wherein the multiple analytic functions are linear combinations of the set of unknown parameters.

5. The process of claim 1, wherein the multiple analytic functions are nonlinear combinations of the set of unknown parameters.

6. The process of claim 1, wherein the set of unknown parameters is a set of field amplitudes, a set of temperatures, a set of pressures, a set of strains, a set of forces, a set of magnetic fields, a set of electric fields, or a set of gravitational fields.

7. A quantum sensor network comprising:
a plurality of quantum sensors, each of which is configured to measure a different function of a set of unknown parameters;
a network topology that connects the plurality of quantum sensors; and
a controller that is configured to:
prepare the plurality of quantum sensors in a known state;
expose the plurality of quantum sensors to the set of unknown parameters;
measure the plurality of quantum sensors; and
use the measurements of the plurality of quantum sensors to calculate the multiple functions of the set of unknown parameters.

8. The quantum sensor network of claim 7, wherein the plurality of quantum sensors is arranged in a linear array.

9. The quantum sensor network of claim 7, wherein the plurality of quantum sensors is arranged in a two-dimensional array.

10. The quantum sensor network of claim 7, wherein the plurality of quantum sensors is arranged in a three-dimensional array.

11. The quantum sensor network of claim 7, wherein the plurality of quantum sensors is qubits, interferometers, or field-quadrature displacement sensors.

12. The quantum sensor network of claim 7, wherein the multiple functions are linear combinations of the set of unknown parameters.

13. The quantum sensor network of claim 7, wherein the multiple functions are nonlinear combinations of the set of unknown parameters.

14. The quantum sensor network of claim 7, wherein the set of unknown parameters is a set of field amplitudes, a set of temperatures, a set of pressures, a set of strains, a set of forces, a set of magnetic fields, a set of electric fields, or a set of gravitational fields.

15. A process for making a quantum sensor network that measures multiple functions, the process comprising:
providing a plurality of quantum sensors, each of which is capable of measuring a different function of a set of unknown parameters;
arranging the plurality of quantum sensors in a network topology; and
connecting the plurality of quantum sensors to a controller.

16. The process of claim 15, wherein the plurality of quantum sensors is arranged in a linear array.

17. The process of claim 15, wherein the plurality of quantum sensors is arranged in a two-dimensional array.

18. The process of claim 15, wherein the plurality of quantum sensors is arranged in a three-dimensional array.

19. The process of claim 15, wherein the plurality of quantum sensors is qubits, interferometers, or field-quadrature displacement sensors.

20. The process of claim 15, wherein the network topology is a star topology, a ring topology, or a mesh topology.

21. The process of claim 15, wherein the controller is a computer.
